(19) United States
(12) Patent Application Publication
(10) Pub. No.: US 2026/0230336 A1
(43) Pub. Date: Aug. 6, 2026

(54) METHODS FOR RAPID AUTHENTICATION AND AUTHORIZATION BETWEEN DEVICES WITH KEY UPDATES

(71) Applicant: CORUH ARGE VE TEKNOLOJI SANAYI TICARET LIMITED SIRKETI, RIZE (TR)

(72) Inventor: CORUH UGUR, RIZE (TR)

(21) Appl. No.: 19/152,017

(22) PCT Filed: Dec. 26, 2023
(86) PCT No.: PCT/TR2023/051719

§ 371 Date: Jul. 30, 2025

(30) Foreign Application Priority Data
Jan. 31, 2023 (TR) 2023001121

(51) Int. Cl. H04L 9/32; H04L 9/08; H04L 9/30

(52) U.S. Cl. CPC H04L 9/3268; H04L 9/0891; H04L 9/3066; H04L 9/3297; H04L 2209/84

(57) ABSTRACT

The method is for enabling identity verification between devices in a system involving at least one trusted authority (100) and at least two devices, communicating with an open key infrastructure. It involves steps performed by a device acting as the source, using a revocation control key installed in each device and updated only in authorized devices by the mentioned trusted authority (100), signing with this key along with an identity information associated with the vehicle (310) and a timestamp to calculate a revocation control value; sending at least a unique device revocation public key along with the mentioned identity information; sending the intended message, the mentioned timestamp, and the mentioned revocation control value signed with the device revocation secret key, which is the pair of the mentioned device revocation public key; and steps performed by a device acting as the target, obtaining the sent timestamp and revocation control value by decoding with the sender device's device revocation public key; generating a revocation

### TECHNICAL FIELD

The invention relates to methods that enable identity verification between devices in systems communicating with an open key infrastructure, involving at least one trusted authority and at least two devices.

### PRIOR ART

In V2X/C-V2X (vehicle to everything/cellular vehicle to everything) communication systems, a Certificate Revocation List (CRL) is used during communication between a unit on the vehicle (OBU) and an element (another vehicle, roadside unit, mobile device, etc.). The CRL represents vehicles and elements that have expired certificates and are not authorized to communicate. During communication, the vehicle/element checks whether another vehicle/element is on the CRL to determine if the data source is authorized.

In V2X/C-V2X communications, applications with an open key infrastructure spend time on CRL-based certificate checks in critical operations between vehicles. Since the list check is performed as a search, as the number of vehicles increases, so does the number of vehicles with revoked licenses, prolonging the control process. In high-speed situations requiring very rapid responses, these delays pose problems in meeting the desired requirements for V2X/C-V2X applications. Additionally, the key pairs in the open key infrastructure used by the onboard electronic units (On Board Unit-OBU) and V2X/C-V2X modems on the vehicles need to be remotely updated at regular intervals. However, in the asymmetric key-using open key infrastructure (Public Key Infrastructure-PKI), securely updating the certificates and the related private/public key sets is still seen as a problem. Especially in situations where access to the endpoint device is limited, the connection in between is not secure, or the endpoint device lacks the capability to establish a secure connection, such as with vehicles, solving this problem is of significant importance.

The time-critical operations being delayed due to CRL-based verifications and the inability to remotely update asymmetric keys

In conclusion, all the problems mentioned above have made it imperative to innovate in the relevant technical field.

### BRIEF DESCRIPTION OF THE INVENTION

The present invention relates to methods that enable identity verification, designed to eliminate the disadvantages mentioned above and bring new advantages to the relevant technical field.

One objective of the invention is to present a method that enables significantly accelerated identity verification in communication systems operating with an open key infrastructure, compared to the current technology.

Another objective of the invention is to present a method that enables communication, identity verification, and updating in an enhanced security manner against attacks.

To achieve the objectives mentioned above and those that will become apparent from the detailed description below, the present invention is a method for enabling identity verification between devices in a system involving at least one trusted authority and at least two devices, communicating with an open key infrastructure. This innovation involves the steps of: calculating a revocation control value using a cancellation control key, loaded into each device and updated only in authorized devices by the mentioned trusted authority, along with an identity information associated with the vehicle and a timestamp, performed by a device acting as a source; sending at least a unique device revocation public key along with the mentioned identity information; sending the intended message, the mentioned timestamp, and the mentioned revocation control value signed with the device revocation secret key, which is the pair of the mentioned device revocation public key; and performed by a device acting as a target, decoding the sent timestamp and revocation control value using the sender device's device revocation public key; generating a revocation control value using the identity information of the sending device, the device revocation control key present in it, and the obtained timestamp; and determining that the sending device is an authorized device if the revocation control values obtained and generated from the sending device are equal. Thus, identity verification can be accelerated without the need for a CRL. This feature, for instance, speeds up the processing of instant telemetry messages in systems used in vehicles.

A possible embodiment of the invention features the mentioned device revocation secret key and device revocation public key as elliptic curve cryptography (ECC) based asymmetric key pairs.

Another possible embodiment of the invention is characterized by a trusted authority device certificate, uniquely created for each device and signed with a trusted authority secret key, for which the corresponding trusted authority public key is distributed to each device. This certificate includes at least the identity information of the relevant vehicle and a device revocation public key, which is the pair to a device revocation secret key assigned to the relevant device. The certificate is sent by the device acting as the source to the device acting as the receiver; the receiver device, upon determining that the source device is authorized, verifies the trusted authority vehicle certificate with the trusted authority public key it possesses.

Another possible embodiment of the invention is characterized by the mentioned identity information being a pseudonym device identity (PID). Thus, communication is facilitated without jeopardizing the recognizability of the actual identities of the vehicles.

Another possible embodiment of the invention is characterized by including a step where the device acting as the receiver checks the trusted authority certificate if the device acting as the sender is determined to be an authorized device. In the current technique, this step is performed before checking the CRL. Thanks to this method, since the trusted authority certificate verification process takes longer compared to the validation process, it prevents unnecessary execution of this step for devices that fail to pass the verification.

Another possible embodiment of the invention is characterized by the device acting as the source sending, in addition to its unique device revocation public key and identity information, the message type, a counter indicating the version of the trusted authority device certificate, the certificate expiration date, and the index information of the valid device key pair in cases where multiple device revocation key pairs exist; also, the trusted authority device certificate includes these details in a signed format. The provision of multiple key pairs and their tracking with indexes ensures that even if the keys are compromised through methods like brute force attacks, the impact is negated as the lifespan of the keys ends and a transition to other keys can be made.

Another possible embodiment of the invention is characterized by the device in the receiver role checking the certificate expiration date, message type, timestamp, counter, and expiration date suitability before proceeding with the revocation control value verification processes.

Another possible embodiment of the invention is characterized by the device in the receiver role verifying the signature of the device in the source role to confirm it is an authorized device.

Another possible embodiment of the invention is characterized by the device in the receiver role processing the message.

The invention also relates to a method for updating a revocation control key (K_{g}), device revocation public key, and device revocation secret key in a method as described above, carried out in a system involving at least one trusted authority and at least two devices, communicating with an open key infrastructure. The innovation involves steps performed by the trusted authority; determining device revocation key pairs not in use in the database, creating an interim revocation key (Kᵢₘ) by multiplying a random number with a selected device revocation public key, generating a new revocation control key by multiplying the interim revocation key (Kᵢₘ) with a device revocation secret key that pairs with the mentioned device revocation public key, previously calculated; associating the last value of the chain with the first version of the revocation control key loaded into each device and containing successive K_{g} hash chain values, determining the next hash chain value in a K_{g} hash chain by applying a hash process to the mentioned hash chain values starting from the first value and associating it with the new revocation control key; encrypting the determined hash chain value with the new revocation control key and signing it with the interim revocation key; sending the encrypted and signed hash chain value, the interim revocation key, and version information to the device to be updated, repeating these steps for each device to be updated; if the devices to be updated have a revocation control key, generating a new revocation control key by multiplying the received interim revocation key with the existing revocation control key; decrypting the received encrypted K_{g} hash chain value with the new revocation control key; generating the current device revocation secret key by multiplying the K_{g} hash chain value obtained with the device's current device revocation secret key; obtaining the current device revocation public key by inversely multiplying the K_{g} hash chain value obtained with the device's current device revocation public key. Thus, structures playing a role in key verification are updated, and devices whose authority will be revoked will not be updated, hence will not be able to perform identity verification.

Another possible embodiment of the invention is characterized by the device, in the absence of a revocation control key, requesting the revocation control key from other devices; if the other devices determine that the message from the requesting device is appropriate, they send the device revocation control key using ECIES (Elliptic Curve Integrated Encryption Scheme).

Another possible embodiment of the invention is characterized by the devices to be updated, upon detecting that there is a difference of at least two between the last version information recorded in them and the version information received with the update request; generating an interim revocation control key by multiplying the received interim revocation key; decrypting the received encrypted K_{g} hash chain value with the interim revocation control key; generating the current interim revocation secret key by multiplying the K_{g} hash chain value obtained with the device's current device revocation secret key; obtaining the interim device revocation public key by inversely multiplying the K_{g} hash chain value obtained with the device's current device revocation public key, and repeating these steps until the K_{g} hash values in between are obtained and the version just before the most recent version is achieved, which is one less than the difference in value.

The invention also relates to a method for updating a trusted authority device certificate in a method as mentioned above, carried out in a system involving at least one trusted authority and at least two devices, communicating with an open key infrastructure. The innovation involves the steps of the trusted authority deciding on the need for an update, incrementing the version of the trusted authority device certificate and sending it to authorized devices for updates, previously calculated; determining the next PKI hash chain value in a PKI hash chain by applying a hash process to the mentioned PKI hash chain values starting from the first value and associating it with the initial version of the trusted authority device certificate loaded into each device, containing successive PKI hash chain values; generating an interim certificate update key (K_{med}) by multiplying a randomly selected number with a trusted authority public key; generating a certificate hash value encryption key (K_{cert}) by multiplying the interim certificate update key (K_{med}) with a certificate secret update key registered with the trusted authority and previously distributed to all devices; encrypting the determined PKI hash chain value with the mentioned certificate hash value encryption key (K_{cert}); sending at least the encrypted PKI hash chain value and the interim key in a signed message to the device; and repeating these steps for all authorized devices, verifying the signature on the device to be updated, generating the certificate hash value encryption key (K_{cert}) by multiplying the received interim certificate update key with the certificate secret update key recorded on the device, obtaining the encrypted PKI hash chain value in the message with the generated certificate hash value encryption key, generating the current certificate secret key by multiplying the obtained PKI hash chain value with the previously recorded certificate secret key on the device, obtaining the current certificate public key by multiplying the current certificate secret key with the ECC parameters, generating the current certificate secret update key by inversely multiplying the ECC parameters with the current certificate secret key, and storing the trusted authority device certificate in the received message for use in communication. This ensures the secure updating of the certificate received from the trusted authority, thereby further enhancing security.

### BRIEF DESCRIPTION OF THE FIGURES

FIG. 1 provides a representative view of the system in which the methods subject to the invention are implemented.

FIG. 2 presents a representative view of the operational steps of the identity verification method.

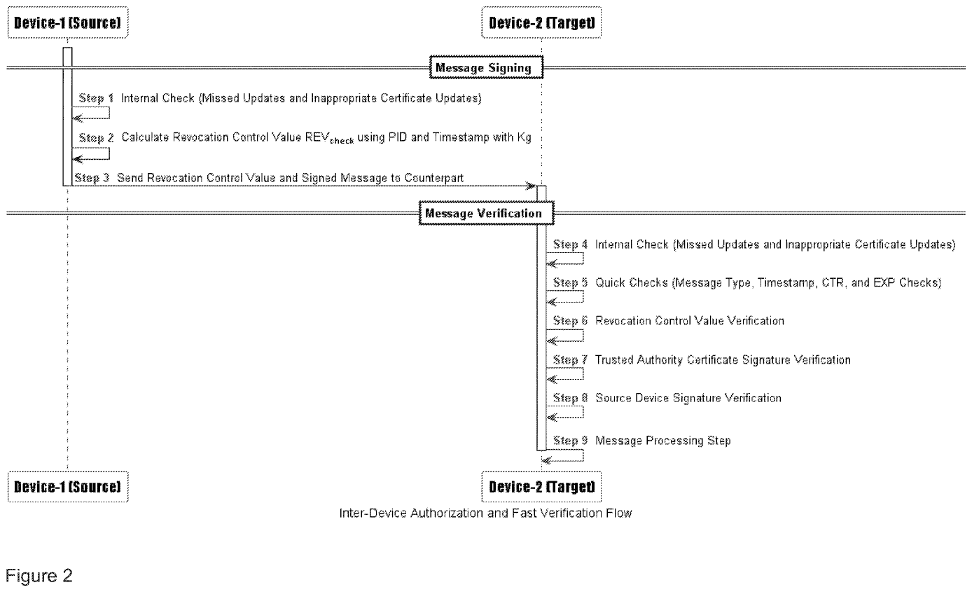

FIG. 3 presents a representative view of the operational steps of the revocation control key update method.

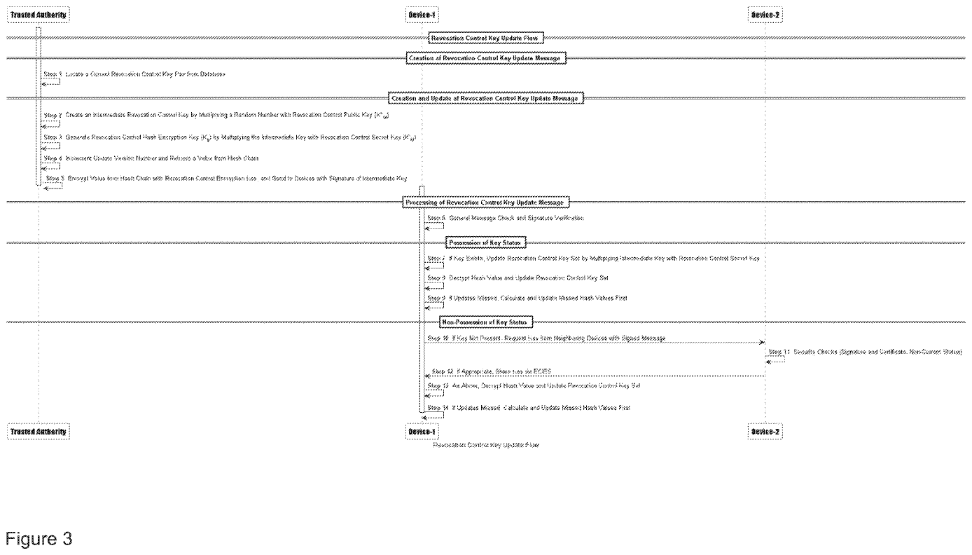

FIG. 4 presents a representative view of the operational steps of the trusted authority device certificate method.

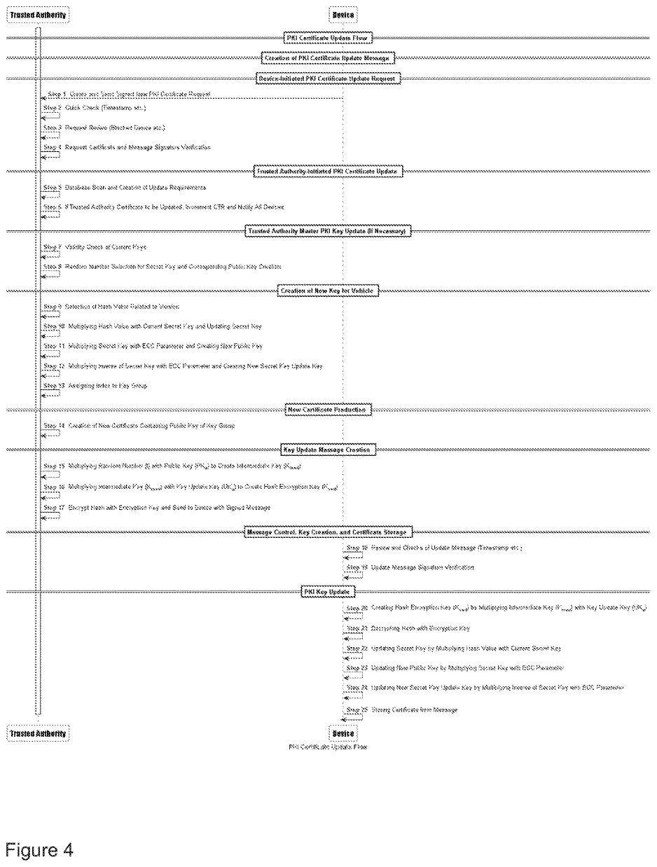

### DETAILED DESCRIPTION OF THE INVENTION

In this detailed description, the subject of the invention is explained with examples solely for the purpose of better understanding, without creating any limiting effect.

In this specification, the results produced by the summary function are referred to as hashes, as is well known in the field.

The following Table 1, Table 2, Table 3, and Table 4 provide explanations and equivalents of the mathematical expressions used in this specification.

TABLE 1

| Symbol | Description |
|---|---|
| [symbol] ₁ | An additive group of prime order q |
| [symbol] ₂ | A multiplicative group of prime order q |
| x∥y | Concatenation of x and y in the specified order |
| [x]^{y} | The first y bits of the sequence x |
| x and \tilde{x} | The new value of x is denoted by \tilde{x} |

TABLE 2

| | |
|---|---|
| sig_{y}(x) | Signature of x with y's secret key. |
| ${CERT}_{u}^{i}$ | The i-th certificate of the device issued by the Trusted Authority (TA) |
| P, Q | Represent the public and secret key generators for |
| | asymmetric key pairs. (P, Q) ∈ [symbol] ₁ and defined |
| | parameters such as the secp256k curve |
| REV_{check} | Revocation control value, using F_{mac.HMAC} (.) or |
| | F_{mac.AES}(.) functions or other suitable MAC |
| | functions for calculations. |
| M | Unique private key identity for updating the required |
| | key pair. Transferred with K_{msg}. It is also uniquely |
| | produced for each key. |
| PIDᵤ | Pseudonym identity number of the devices, derived |
| | from the real identity information using the |
| | [F_{mac.HMAC}(RIDᵤ, K_{pid})]³² function and used in |
| | certificates. |
| K_{pid} | Secret key for generating PID (16 bytes), located at |
| | the Trusted Authority. |
| ${PK}_{m}^{i} , {SK}_{m}^{i}$ | $Trusted authority public ( {PK}_{m}^{i} ) and secret ( {SK}_{m}^{i} ) key$ |
| | pair. Trusted authority certificates and messages |
| | are signed with this and the public key is sent to |
| | devices for verification. |
| ${PK}_{u}^{i} , {SK}_{μ}^{i} , {UK}_{u}^{i}$ | Key group of device's i-th certificate public key |
| | $( P {K}_{u}^{i} ) , secret key ( {SK}_{u}^{i} ) , and certificate secret update$ |
| | $key ( {UK}_{u}^{i} ) . Produced by the {F}_{gen . PKI} ( . ) function .$ |
| ${K}_{i}^{-} , {K}_{i}^{+}$ | $i - th vehicle revocation public ( {K}_{i}^{+} ) and secret ( {K}_{i}^{-} )$ |
| | key pair. Produced by the F_{gen.SECV2X}(.)function. |
| K_{g} | Revocation control key ∈ [symbol] ₂ |
| K_{cert} | Certificate hash value encryption key |
| Kᵢₘ | Interim key for updating K_{g} ∈ [symbol] ₂ |

TABLE 3

| | |
|---|---|
| K_{med} | Interim certificate update key |
| K_{msg} | Trusted authority key update message. |
| CRL | Device certificate revocation list. |
| REV_{msg} | Revocation control message signed by the |
| | trusted authority. |
| F_{INVMOD} (x, y) | Modular inverse of base x to y. |
| F_{RAND}(.) | Secure random number generation function. |
| F_{SHA1}(x) | Cryptographic SHA1 hash of x. |
| F_{enc.AES}(x, y) | Using AES CBC function to encrypt x with |
| | key y. |
| F_{dec.AES}(x, y) | Using AES CBC function to decrypt x with |
| | key y. |
| F_{mac.HMAC}(x, y) | Using cryptographic MAC process with |
| | SHA-1 and key y for x. |
| F_{mac.AES}(x, y) | Using AES CBC MAC process with key |
| | y for x. |
| F_{enc.ECIES}(x, y) | Using ECIES function to encrypt x with key y. |
| F_{dec.ECIES}(x, y) | Using ECIES function to decrypt x with key y. |
| F_{sig.ECDSA}(x, y) | Creating an x signature with private key y |
| | using the ECDSA scheme. |
| F_{val.ECDSA}(x, y, z) | Validating y's signature of x with public key |
| | z using the ECDSA scheme. |
| [ [symbol] , [symbol] ] = | Updating revocation control key pairs K⁺, K⁻ |
| F_{upd.EKI}(K⁺, K⁻, v) | with differential value v to obtain a new |
| | key pair [symbol] , [symbol] |
| [PK, SK, UK] = | Generating ECDH PKI public (PK), private |
| F_{gen.PKI}(rnd) | (SK), and secret update (UK) key groups |
| | with random value rnd. |

TABLE 4

| | |
|---|---|
| [K⁺, K⁻] = | Generation of ECDH revocation control public |
| F_{gen.SECV2X}(rnd) | (K⁺and secret (K⁻) key pair with random value |
| | rnd. |
| C | Device certificate count. |
| j | Hash chain count. |
| m | Key pair or group size. |
| l | Key pair or group pool size |
| v ϵ [symbol] | Initial hash chain value |
| V | Hash chain set |
| Uₚ, Uₛ | Public (Uₚ) and secret (Uₛ) key pool for revocation |
| | control, maintained on the Trusted Authority. |
| RPᵤ, RSᵤ | Public (RPᵤ) and secret (RSᵤ) keys distributed to |
| | devices for revocation control. |
| [symbol] | Telemetry messages and other data sent between |
| | devices. |
| Tₛₜₐₘₚ | Current timestamp value. |
| ver, verₗₐₛₜ, | Current, last received, and missed version. |
| ver_{\|missed} | |
| vⱼ₋ᵥₑᵣ | Hash chain value of the version. |

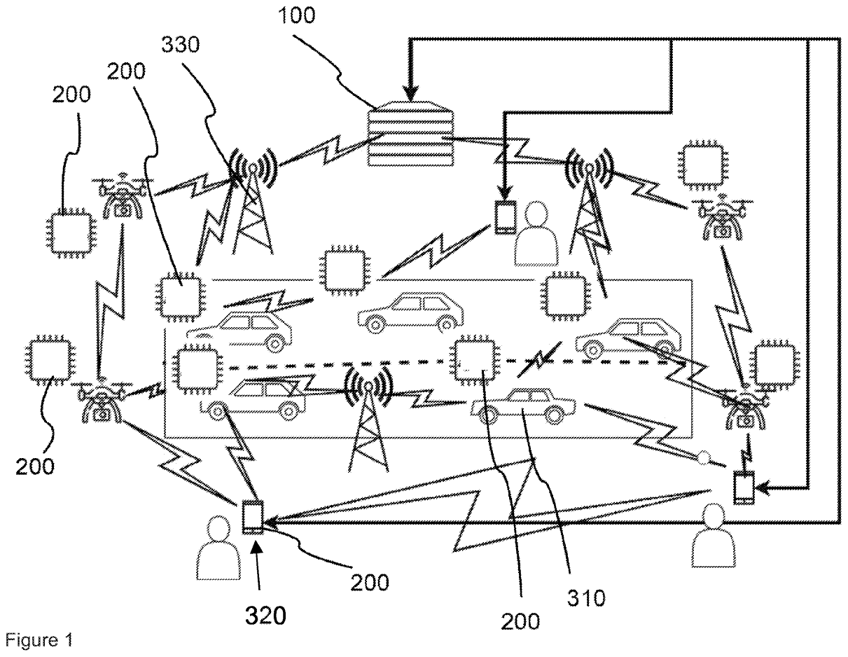

The invention, referring to FIG. 1, encompasses a communication system and the methods performed by this system, which enable devices to communicate securely with each other, perform identity verification, and update certificates.

Here, the mentioned devices refer to electronic devices (200) that facilitate communication between elements such as vehicles (310), mobile devices (320), and roadside units (330).

The aforementioned elements (vehicle (310), mobile device (320), roadside unit (330)) each incorporate a device. The devices mentioned above refer to those involved in communication, requiring certificate updates, and needing identity verification during communication with each other. These devices can include a processing unit and a communication unit that facilitates data exchange for the mentioned processing unit. The processing unit can be a microprocessor, a chip, etc. The communication unit is arranged to perform wireless data exchange and may include active or passive antennas. In a possible embodiment of the invention, the devices could be units known in the field as On-Board Units (OBU). In the present invention, the method steps executed by the devices operate within the operating system run by the processing unit or within the hardware. In a possible embodiment of the invention, the devices can also be PKI-using credit cards, electronic cards, unmanned aerial vehicle communication units, etc.

The system subject to the invention includes a trusted authority (100) that facilitates the authorization and updating of vehicles (310). This trusted authority (100) can be a server and is capable of communicating with devices via a communication network. This communication network can include well-known sub-components in the field, such as satellites, access points, roadside units (330), etc. The trusted authority (100) is also known in the field as the Trusted Authority (TA).

For the implementation of the method subject to the invention, a revocation control key is provided in each device. The secret keys are updated for non-revoked devices by the trusted authority (100) using hash chains provided at the trusted authority (100) and through the device revocation secret key and device revocation public key. During communication between devices, each device creates its unique pseudonym identity information from its real identity information using a keyed hash function. A keyed hash is created using the pseudonym identity information and time information as inputs with the revocation control key and is sent to the other device along with telemetry data. The receiving device (in this scenario, for example, a vehicle (310)), without the need for the Certificate Revocation List (CRL), checks the sent hash value and performs the verification process more quickly without the need for the CRL check step.

Below, the operational steps of the method, which has been summarized above, are explained.

The method includes a setup and initialization phase. During the setup and initialization phase, the trusted authority (100) creates the necessary keys, parameters, hash chains, and other elements required for the system's operation and facilitates the transfer of the appropriate elements to the vehicles (310).

### Setup and Initialization Phase:

The trusted authority (100) selects Elliptic Curve Cryptography (ECC) parameters (P) for the public key and ECC parameters (Q) for the secret key to generate asymmetric key pairs using ECC-based methods.

The trusted authority (100) creates a pool of device revocation key pairs, which include multiple device revocation secret keys and device revocation public keys generated using ECC-based methods, with a portion of them to be distributed to vehicles (310).

Below are the procedural steps related to the creation of these key pairs.

A random kᵢ value is chosen

$${k}_{i} ∈ {ℤ}_{q}^{*}$$

The randomly chosen number is multiplied with the Q parameter as given in the formula below to generate the device cancellation private key.

$${K}_{i}^{-} = {k}_{i} Q ∈ {𝔾}_{1}$$

The inverse of the randomly chosen number is multiplied with the P parameter as given in the formula below to generate the device cancellation public key.

$${K}_{i}^{+} = {k}_{i}^{- 1} P ∈ {𝔾}_{1}$$

The generated key pair is added to the device cancellation key pool.

$$\{ {K}_{i}^{-} , {K}_{i}^{+} \}$$

The steps provided above are repeated until the desired number of key pairs is obtained.

The process of creating the device cancellation key pair pool is completed after the repetitions. When all the keys in the device cancellation key pair pool are used, the above steps are repeated to add new key pairs to the pool.

The first version of the cancellation control key is generated. The cancellation control key, after the system has started operating, will be sent to all authorized devices, including vehicles (310), roadside units, etc., instead of CRL, to allow them to detect and manage vehicles whose authorization has been revoked accordingly.

Cancellation control key generation can be as follows, for example, in the following process steps.

Random two numbers (t, m are selected. The selected numbers are divided and multiplied by P to create an intermediate cancellation key (Kᵢₘ. The m value here will be selected from a K_{g} hash chain in the subsequent process steps. As shown in the formulas below, the intermediate cancellation key is multiplied by the Q value to create the initial cancellation control key (K_{g}).

$$t ∈ {ℤ}_{q}^{*} ; m ∈ {ℤ}_{q}^{*} ; {K}_{i m} = ( \frac{t}{m} ) P ∈ {𝔾}_{1} ;$$

$${K}_{g} = {K}_{i m} Q ∈ {𝔾}_{2}$$

As a result of this process, the initial version of the cancellation control key (K_{g}) is created.

The reliable authority (100) creates a reliable authority (100) key pair. The reliable authority (100) key pair is an asymmetric key pair and consists of a reliable authority (100) private key and a reliable authority (100) public key. These keys will be used by the reliable authority (100) to generate device certificates and sign messages sent from the reliable authority (100). The reliable authority (100) public keys will also be distributed to elements (vehicles (310), roadside units (330), credit cards, mobile devices (320), etc.) or devices. The reliable authority (100) device certificate mentioned here is signed by the reliable authority (100) with the reliable authority (100) private key. It represents a certificate sent to each device, indicating that the device has been authorized by the reliable authority (100). Devices can verify this certificate by decrypting it with the reliable authority (100) public key.

The first reliable authority (100) key pair is generated as follows.

A random number is selected. The chosen number is considered the private key, and then the private key is multiplied by the Q value to create the public key. Below are the mathematical formulas for these steps:

$$S {K}_{m} ∈ {ℤ}_{q}^{*} ;$$

$$P {K}_{m} = S {K}_{m} Q$$

The reliable authority (100) generates multiple reliable authority (100) private and public key pairs. Devices have multiple reliable authority (100) key pairs. In case the validity period of any reliable authority (100) key pair expires, it is ensured that the device can operate with other key pairs. When a device receives a message from another device, it selects the reliable authority (100) public key based on the key index in the message and verifies the message.

The reliable authority (100) determines the signature and hash chain functions. Hash functions can be either SHA-256 or SHA-512 functions. Other hash functions can also be used, and the mentioned functions are provided as examples without limitation.

The main certificate versions are tracked with indexes. Current indexes are incremented to update the versions. Similarly, current vehicle (310) key pairs and cancellation key are also tracked with indexes. The reliable authority (100) resets the reliable authority (100) device certificate version index and the vehicle (310) key pair and cancellation key version indexes to zero.

The reliable authority (100) updates the reliable authority (100) device certificate versions through a hash chain value obtained from a hash chain. The reliable authority (100) determines an initial PKI hash chain value for use in PKI updates. A hash chain is created based on the initial PKI hash chain value for use in updates. The initial value of the hash chain is sensitive data and must be protected. By taking advantage of the difficulty of reversing the hash chain, values are used from the end of the chain, and if there is a missed update process, forward hash calculations can be performed independently to complete the update process.

For example, let the PKI initial hash chain value be hash-1. By applying hash in a chained manner to hash-1, a hash chain is obtained, each having hash values for each version. While the hash chain is created in one direction, the versions are created in the other direction. For example, let's consider a hash chain with 3 hash values, and let hash-1 be the initial hash value. Hash-1, hash-2, and hash-3 are all hash values in the hash chain. Hash-3 is used for the starting version index, for example, V=0; hash-2 is used for V=1, and hash-3 is used for V=2. In other words, the initial hash value is used in the final version. This structure will be explained in more detail during the Reliable Authority (100) device certificate update phase and the cancellation control key (K_{g}) update phase.

Reliable Authority (100) also updates the cancellation control key using a hash chain. Accordingly, an initial K_{g} hash chain value is determined, and starting from this value, a K_{g} hash chain is created.

After the mentioned keys, hash chains, certificates, and other elements are produced, suitable ones are loaded onto the devices. Some of the loading processes are performed during the production of vehicles (310), while others can be done later using one of the known methods in the field.

Methods for cancellation control are loaded onto the devices. These methods can include functions and methodologies used for cancellation control key verification methods and trusted authority (100) device certificate cancellation control methods. Hash function methods are loaded onto vehicles (310). The hash function methods referred to here include the functions and methodologies that devices will use during hash processing.

Cancellation control keys (K_{g}) are loaded onto the devices. Each device is loaded with a version information that indicates the version of their device cancellation key pair. The version information of the certificate key pair is loaded onto each device. ECC group manufacturers are loaded onto the devices. In a possible implementation of the invention, multiple trusted authority (100) public keys are loaded onto each device. These trusted authority (100) public keys are associated with index numbers.

Each device is loaded with a device cancellation key pair (device cancellation private key and device cancellation public key). In a possible implementation of the invention, each key pair includes an expiration date triggered by time, and multiple key pairs are provided to each vehicle (310). This prevents brute force decryption of the key pairs and ensures their periodic renewal. The assigned key pairs are associated with the devices (roadside unit (330), etc.) in a database for use in authorization cancellation control operations.

Each device is loaded with a certificate key pair (certificate private key, certificate public key, and certificate private update key).

Below are the sample process steps used for creating device certificates and certificate key pairs, as well as generating a certificate private update key by the Trusted Authority (100):

A certificate private key is accepted by selecting a random number.

$$S {K}_{u} ∈ {ℤ}_{q}^{*}$$

The relevant public key (certificate public key) is created as follows by multiplication.

$$P {K}_{u} = S {K}_{u} Q$$

The certificate secret update key required for key updates is created as follows, by taking the inverse of the certificate secret key as shown in the formula below:

$$U {K}_{u} = S {K}_{u}^{- 1} P$$

For example, a reliable authority (100) device certificate can be obtained as follows.

$${CERT}_{u}^{i} ( {PID}_{u} , {EXP}_{u}^{i} , {CTR}_{TA} , {PK\_IND}_{TA} , {PK}_{u}^{i} , {PK\_IND}_{u}^{i} , {sig}_{TA} ( {PID}_{u} ‖ {EXP}_{u}^{i} ‖ {CTR}_{TA} ‖ {PK\_IND}_{TA} ‖ {PK}_{u}^{i} ‖ {PK\_IND}_{u}^{i} ) )$$

Each key group has an index. Certificates, private keys, vehicle (310) update private keys, and secure key storage hardware or software are securely loaded onto the devices.

The aforementioned trustworthy authority (100) certificate sequentially contains the pseudo-device identification number, the expiration date of the certificate, a counter that validates the validity of the key used to create the certificate, the public key index of the key used to create the certificate, the device cancellation public key, the device's general key index, and all of these inputs are used to generate the signature with the main private key.

The trustworthy authority (100) stores the device key pairs sent to the devices, associating them with the respective devices, in a way that specifies the devices.

As a result of the above installations, the trustworthy authority (100) contains the device cancellation key pool, device cancellation key pairs, information about the assigned devices, etc. It also includes a counter for the validity check of device certificates, the sent certificates, the trustworthy authority (100) key pair (trustworthy authority (100) private key and trustworthy authority (100) public key), the cancellation key (K_{g}), K_{g} hash chain, PKI hash chain, and general parameters for ECC (H, h, P and Q).

In devices, the trustworthy authority (100) device certificate, certificate key pair (certificate private key, certificate public key), certificate secret update key, at least one device cancellation key pair (device cancellation public key, device cancellation private key), trustworthy authority (100) public keys, trustworthy authority (100) public key indices, cancellation key (K_{g}), the aforementioned general parameters for ECC, stored device cancellation key pair version, the latest received device cancellation key pair version, the latest received certificate key pair version, and stored certificate key pair version information are included.

The authentication phase involves;

One of the innovative methods of the present invention is to enable accelerated authentication by eliminating the need for CRL. Following the described process steps, when the system becomes operational, the following procedures take place during messaging.

In a possible configuration of the invention, the device checks the counter (CTR) and version in the certificates. If the CTR value is incorrect or the version is outdated, it is determined that the current cancellation key (K_{g}) and/or certificates need updating. If an update is required, the device stops sending messages to its surroundings and initiates the key update and certificate update request flows. If the device certificate version (i.e., certificate key pair) is outdated, it requests an update from the trusted authority (100). If the device cancellation key pair is outdated, it requests an update from other devices or the trusted authority (100). The steps for updating will be explained in more detail in the certificate key pair update and device cancellation key pair update phases.

If the versions are appropriate, the device follows the steps below when it wants to send a message. The message mentioned here can contain telemetry information, etc.

The device generates a cancellation control value, which can be generated as follows.

$$R E {V}_{check} = {F}_{mac . HMAC} ( {[ {K}_{g} \cdot x ]}^{128} , {PID}_{s} ‖ {T}_{stamp} )$$

The cancellation control value is generated by using the cancellation control key to sign F_{mac.HMAC}(.) or F_{mac.AES}(.), along with the device's pseudo-identity number (PID) and timestamp.

The device then generates the message to be sent later. The message includes the message type, the timestamp of the message, the Trusted Authority (100) device certificate, the signature of the message along with the device cancellation private key with the timestamp, and the cancellation control value.

$$Message = < TELEMETRY\_MSG ‖ ℳ ‖ {T}_{stamp} ‖ {CERT}_{u}^{i} ‖ {sig}_{u} ( TELEMETRY\_MSG ‖ ℳ ‖ {T}_{stamp} ) ‖ {REV}_{check} > \text{?}$$

$$\text{?} \text{indicates text missing or illegible when filed}$$

The device sends the generated message.

The other device receiving the sent message can perform version checks and update operations as described above. It can also verify the message format, timestamp, certificate counter (CTR) correctness, expiration time correctness, and more. To check the cancellation control value, it uses the timestamp and PID values obtained from the message, and with its registered cancellation control key (K_{g}) and the appropriate HMAC functions mentioned above, it generates the cancellation control value. If the generated cancellation control value matches the received cancellation control value, the cancellation control process is successfully completed. This way, cancellation control is achieved in a significantly accelerated manner compared to the conventional technique of searching through a long list like CRL. Authorized vehicles (310) whose privileges have been revoked are identified as unauthorized because they cannot update their cancellation control key. As a result, the cancellation control values they generate do not match the cancellation control values generated by the target vehicle (310), and their sent messages are disregarded.

After cancellation control has been established, the message signature

$$( c e r {t}_{u}^{i} )$$

contained in the certificate belonging to the trusted authority (100) is verified using the trusted authority (100) public key (certificate validation).

After certificate validation, the signature of the transmitting vehicle (310) is verified using the device cancellation public key. Following these procedures, the message content is used by the device.

### The Device Cancellation Key Update Stage

Another innovative method of the invention is to update the device cancellation control key. The device cancellation control key update is performed through the K_{g} hash chain and the existing K_{g}.

The reliable authority (100) produces a new cancellation control key (K_{g}) for the next version. The newly generated K_{g} ensures the update of all vehicle (310) key pairs, and the vehicles (310) are required to perform this update. After the update, all authorized vehicles (310) have the same updated K_{g}. Devices that cannot update their K_{g}, i.e., devices that have been canceled, cannot send messages to each other since they cannot pass the identity verification stage described above.

Below, example procedural steps for the production of a new cancellation control key (K_g) are provided:

In the trusted authority (100) database, the following key pairs with the ID “M” that have not yet been canceled in the device cancellation key pool are being searched. These keys are represented as follows:

$$Public Key : {K}_{M}^{-} = {k}_{M} Q ,$$

$$Private Key : {K}_{M}^{+} = {k}_{M}^{- 1} P$$

A random number t is selected;

$$t ∈ {ℤ}_{q}^{*}$$

The selected random number is multiplied by the cancellation control public key to create the intermediate key used in the key update, as follows in the formula.

$${K}_{im} = t {K}_{M}^{+}$$

To create the new cancellation control key, the intermediate key is generated using the device cancellation control secret key with the following formula.

$${K}_{g} = {K}_{i m} {K}_{M}^{-}$$

The device cancellation key pair version

$$( v e {r}_{M}^{s ecv 2 x} )$$

is incremented by one.

The hash function is applied to the current K_{g} hash chain value to obtain the next version's K_{g} hash chain value, and it is encrypted symmetrically as follows.

$$e n {c}_{{K}_{g}} ( {v}_{j - v e {r}_{M}^{secv 2 x}}^{s ecv 2 x} ) = {F}_{enc . AES} ( {[ {K}_{g} \cdot x ]}^{128} , {v}_{j - v e {r}_{M}^{s ecv 2 x}}^{s ecv 2 x} )$$

The update message prepared by the Trusted Authority (100) contains the new version of the K_{g} hash chain value, the intermediate key, and the old K_{g} hash value encrypted with the new K_{g}. The update message is as follows.

$${K}_{msg} = ( v e {r}_{M}^{s ecv 2 x} ‖ {K}_{i m} ‖ en {c}_{K g} ( {v}_{j - v e {r}_{M}^{s ecv 2 x}}^{s ecv 2 x} ) )$$

The signed update message, generated by the Trusted Authority (100), is as follows:

$$R E {V}_{msg} = ( REVOC\_REQ ‖ {K}_{msg} ‖ {T}_{stamp} ‖ {PK\_IND}_{T A} ‖ {sig}_{T A} ( REVC\_REQ ‖ {K}_{msg} ‖ {T}_{stamp} \vert \vert {PK\_IND}_{T A} )$$

The prepared message is sent to the device.

The receiving target device verifies the message type, message certificate, and message timestamp. If any of these are incompatible, the message is discarded. If they are valid, the message is parsed and stored.

If the message type (M) in the message is present on the receiving device, the device uses its cancellation secret key to multiply it by the intermediate key, resulting in the cancellation key being generated as follows:

$${K}_{g} = {K}_{i m} {K}_{M}^{-}$$

After this process, the current cancellation key (K_{g}) is replaced with the new cancellation key, ensuring that it is updated.

With the following processes, the current device cancellation key pairs are updated, ensuring that the next update operations can be carried out securely.

The encrypted K_{g} hash chain value, encrypted with the created cancellation key (K_{g}), is decrypted as follows to obtain the K_{g} hash chain value.

$${v}_{j - v e {r}_{M}^{s ecv 2 x}}^{secv 2 x} = {F}_{dec . AES} ( {[ {K}_{g} \cdot x ]}^{128} , {enc}_{{K}_{g}} ( {v}_{j - v e {r}_{M}^{s ecv 2 x}}^{s ecv 2 x} ) )$$

By checking the difference between the latest received version and the current version, it is determined whether there has been a missed update. If there is no missed update, the K_{g} hash chain value and its reverse are multiplied with the device cancellation secret key and the device cancellation public key, respectively, to create the new vehicle (310) control secret key and new vehicle (310) control public key as follows.

$${\tilde{K}}_{i}^{-} = {v}_{j - v e r} {K}_{i}^{-}$$

$${\tilde{K}}_{i}^{+} = ( \frac{1}{{v}_{j - v e r}} ) {K}_{i}^{+}$$

The term “missed update” mentioned here refers to a situation where there is a difference of at least 2 between the latest received version and the current version.

If there is a missed update, the current K_{g} hash chain value is used to obtain the hash values used in missed updates by taking at least 2 (or more) hash values back from the current version. In the update process, starting from the last K_{g} hash chain value, the multiplication operation is performed as described above, and this process is repeated in a chain-like fashion until it reaches the latest received version. The symbolic formulas for these operations are provided below. The result obtained in each operation is used as input in the next operation.

$${\tilde{K}}_{i}^{-} = {v}_{j - v e {r}_{missed}} {K}_{i}^{-}$$

$${\tilde{K}}_{i}^{+} = ( \frac{1}{{v}_{j - v e {r}_{missed}}} ) {K}_{i}^{+}$$

For example, if a device has the current version 1 and the last received version is also 1, and it receives a version update with an index of 3, it detects a missed update. Version 1 is associated with hash3 in the K_{g} hash chain, version 2 is associated with hash2 in the K_{g} hash chain, and version 3 is associated with hash1 in the K_{g} hash chain.

The device has the hash-3 value for version 1 and the device cancellation private key and device cancellation public key for version 1. First, the missed update operation is performed with hash3 value as follows.

$${K}_{2}^{-} = hash 3 \cdot {K}_{1}^{-}$$

$${K}_{2}^{+} = ( \frac{1}{h ash 3} ) {K}_{1}^{+}$$

The partially updated device cancellation key pair, hashed with hash2 value, is multiplied by the updated device cancellation key pair to make the vehicle (310) control key pair compatible with version 3.

$${K}_{3}^{-} = h ash 2 \cdot {K}_{2}^{-}$$

$${K}_{3}^{+} = ( \frac{1}{h ash 2} ) {K}_{2}^{+}$$

The same update is also performed on the reliable authority (100) side, ensuring that the keys are synchronized on both sides.

If the recipient device does not have a device cancellation key pair, a new K_{g} cannot be created, and the K_{g} hash chain value cannot be decrypted, resulting in the inability to create an updated device cancellation key pair. In this case, the recipient device requests the encrypted cancellation key (K_{g}) from other devices using the message below.

$$〈 msg = KG\_KEY \_REQ ‖ {ver}_{receiνed} ‖ {ver}_{stored} ‖ {T}_{stamp} ‖ {PID}_{s} \vert \vert {PK}_{s}^{i} ‖ {PK\_IND}_{s}^{i} ‖ {EXP}_{s}^{i} ‖ {CTR}_{T A} ‖ {PK\_IND}_{T A} ‖ {sig}_{T A} ‖ {sig}_{OBU} 〉$$

The device requesting updates (key request) performs checks on the message type, counter, and expiration date. In case of any issues, it commands the Trusted Authority (100) to update its own certificates and keys. If there are no issues, the received message is securely sent to the desired recipient using ECIES (Elliptic Curve Integrated Encryption Scheme) encryption with the recipient's device cancellation key (K_{g}). The recipient device performs certificate and version checks, then decrypts the message using ECIES to obtain the cancellation key (K_{g}). It decrypts K_{g} and the K_{g} hash chain value to perform the key update processes described above. Similarly, on the server side, similar processes are performed for the device requesting keys.

### Device Certificate Update Phase

The trusted authority certificates (100) loaded in the initialization phase of devices and the keys associated with them need to be updated over time. For the update operations to be carried out remotely, it is necessary to securely deliver or securely generate the vehicle (310) certificate key group associated with the certificates of the related vehicles.

The update process occurs in two ways. In the first case, the device itself can request an update with a new certificate request. In the second case, the trusted authority (100) can scan its own database and send messages for devices that need updating. Before creating a certificate, the trusted authority (100) checks its own trusted authority (100) key pair and creates a new trusted authority (100) key pair if there is a time-dependent weakness. The time-dependent weakness referred to here denotes situations like the expiry of key groups' expiration dates. The trusted authority (100) obtains the newly created device certificates with the newly created key groups.

The device whose certificate will be updated is first located in the database through the device revocation key group. From the PKI hash chain, a new PKI hash chain value is obtained according to the current key's update version. To update the certificate private key, a new certificate private key is created by multiplying the new PKI hash chain value with the certificate private key. The newly created certificate private key is multiplied with Q to form the relevant new certificate public key. The inverse of the new certificate private key is multiplied with P to create the new relevant certificate private update key. This new device certificate key group is assigned an index.

After the device certificate key group is created, the trusted authority (100) generates a new trusted authority (100) device certificate with the new keys.

To send the newly created trusted authority (100) device certificate to a device, a random number is selected. The selected number is multiplied with the existing certificate's public key on the device to obtain the certificate update intermediate key (K_{med}). The certificate hash value encryption key (K_{cert}), which will encrypt the necessary hash value to update the certificate key group, is created from the product of the certificate update intermediate key and the certificate private update key. The resulting K_{cert} encrypts the PKI hash chain value as follows.

$$e n {c}_{{K}_{cert}} ( {v}_{j - v e {r}_{M}^{c e τ t}}^{c e r t} ) = {F}_{enc . AES} ( {[ {K}_{c e r t} \cdot x ]}^{128} , {v}_{j - v e {r}_{M}^{cert}}^{c e r t} )$$

The certificate is sent to devices in the following message format.

$$NEW\_CERT \_RESP ‖ {T}_{stamp} ‖ {CERT\_NEW}_{u} ‖ {K}_{med} ‖ en {c}_{{K}_{cert}} ( {v}_{j - v e {r}_{M}^{cert}}^{c e r t} ) ‖ {sig}_{T A}$$

The recipient device parses the message and processes it after checking the timestamp and signatures. First, the certificate private update key is multiplied with the certificate update intermediate key to create the certificate hash value encryption key. The related formula is provided below:

$${K}_{c e r t} = {UK}_{u} {K}_{med}$$

The encrypted PKI hash chain value, encrypted with the created certificate hash value encryption key, is decrypted and then multiplied with the certificate private key to update the certificate private key. The updated new certificate private key is multiplied with Q to update the relevant new certificate public key. The inverse of the new certificate private key is multiplied with P to update the new relevant certificate private update key. The previously created and received certificate, as the trusted authority (100) device certificate, is stored. Thus, the certificate is updated and the relevant key groups necessary for the next update are also updated.

### Device Addition Phase

Prior to adding a new vehicle (310) to the system, the trusted authority (100) checks whether there are a predetermined number of empty key pairs in the device revocation key pool and, if the number falls below the mentioned count, device revocation key pairs are created for addition to the pool. This process is carried out similarly to the installation and initialization phases. In a possible configuration of the invention, while creating a trusted authority (100) device certificate for devices, a random one from the trusted authority (100) key pairs is selected. The key, certificate, hash function, and parameters created at this stage are securely loaded onto the devices, as in the initialization and installation phases.

### Device Removal Phase

The trusted authority (100) deactivates the pseudo-identity number of the device that is to be removed from the system, i.e., whose authorization is to be revoked. As previously mentioned, the trusted authority (100) contains multiple trusted authority (100) device certificates, each with indexes. The certificate counter of the trusted authority (100) device certificate at the index belonging to the deactivated devices is increased, and a command is sent to update the certificates of devices that have the related trusted authority (100) device certificate. Thus, the certificates of other vehicles (310), except for the deactivated vehicles (310), are updated.

Since the deletion process would take a long time with the current setup, devices are first updated with the device revocation key pair to prevent them from sending messages. Only after this step, the deletion process can proceed.

To remove and prevent communication of the desired vehicle (310) from the system, the certificate counter is used. In this case, as long as the device is active, it requests a certificate at certain intervals. When the obstruction is resolved, the device is sent an updated certificate again. In this way, the device can be reintegrated into the system.

The scope of protection of the invention is specified in the claims provided in the annex and cannot be limited to the examples described in this detailed explanation. Indeed, it is clear that a person skilled in the art can present similar configurations without departing from the main theme of the invention, in light of the above descriptions.

### REFERENCE NUMBERS GIVEN IN THE FIGURE

100 Trusted Authority
200 Electronic Device
310 Vehicle
320 Mobile Device
330 Roadside Unit

1. A method for ensuring identity verification among devices in a system communicating with a public key infrastructure, comprising at least one trusted authority and at least two devices; characterized by comprising the steps:
calculating a revocation control value using an identity credential and a timestamp associated with a vehicle, and signed with a revocation control key loaded on each device in the same manner and updated only by the mentioned trusted authority on authorized devices;
sending at least a unique device revocation public key, the mentioned identity credential, the message to be sent, the mentioned timestamp, and the mentioned revocation control value, signed with the device revocation private key, which is the pair of the mentioned device revocation public key;
performed by a device acting as a source function;
and the steps:
obtaining the sent timestamp and revocation control value by decrypting with the device revocation public key of the sending device;
generating a revocation control value using the identity credential received from the sending device, the device revocation control key present in it, and the obtained timestamp; and
determining that the sending device is an authorized device if the revocation control values obtained and generated from the sending device are equal performed by a device acting as a target function.

2. A method according to claim 1, characterized in that the revocation control value is produced with either the F_{mac.HMAC}(.) or F_{mac.AES}(.) functions.

3. A method according to claim 1, characterized in that the mentioned device revocation private key and device revocation public key are elliptic curve cryptography (ECC) based asymmetric key pairs.

4. A method according to claim 1, characterized in that the mentioned identity credential is a pseudo device identity credential (PID).

5. A method according to claim 1, characterized in that the trusted authority sends a trusted authority device certificate, uniquely created for each device and signed with a trusted authority (100) private key, whose counterpart is a trusted authority public key distributed to each device. This certificate includes at least the identity information of the relevant vehicle and a device revocation public key, which is the pair of a device revocation private key assigned to the relevant device. The recipient device, upon determining that the device acting as the source function is authorized, verifies the trusted authority vehicle certificate with the trusted authority public key it possesses.

6. A method according to claim 5, characterized in that it includes the step of verifying the trusted authority certificate by the device acting as the recipient, upon determining that the device functioning as the sender is an authorized device.

7. A method according to claim 6, characterized in that the device acting as the source function, in addition to a unique device revocation public key and identity information, also sends message type, a counter indicating the version of the trusted authority device certificate, the certificate expiration date, and in case of multiple device revocation key pairs, the index information of the current valid device key pair; and that the signed trusted authority device certificate also includes these informations.

8. A method according to claim 7, characterized in that the device in the role of the receiver checks the certificate expiration date, message type, timestamp, counter, and expiration date appropriateness before proceeding with the revocation control value verification processes.

9. A method according to claim 6, characterized in that the device in the role of the receiver checks the signature of the device in the role of the source to determine if it is an authorized device.

10. A method according to claim 1, characterized in that the device in the role of the receiver processes the message.

11. A method for updating a revocation control key (K_{g}), device revocation public key, and device revocation private key in a system comprising at least one trusted authority and at least two devices, communicating via a public key infrastructure and performing a method as in claim 1, characterized by comprising the steps;
identifying unused device revocation key pairs in the database;
generating an intermediate revocation key (Kᵢₘ) by multiplying a random number with a selected device revocation public key;
creating a new revocation control key by multiplying the intermediate revocation key (Kᵢₘ) with a device revocation private key, which is the pair of the mentioned device revocation public key, previously calculated;
associating the last value of the chain with the first version of the revocation control key, loaded on each device, containing successive K_{g} hash chain values obtained by applying the hash process to the mentioned hash chain values sequentially from the first value, determining the next hash chain value in a K_{g} hash chain and associating it with the new revocation control key;
encrypting the determined hash chain value with the new revocation control key and signing it with the intermediate revocation key;
sending the encrypted and signed hash chain value, the intermediate revocation key, and version information to the device to be updated;
being performed by the trusted authority, and repeating these steps for each device to be updated, and
comprising the steps:
if they have a revocation control key, creating a new revocation control key by multiplying the received intermediate revocation key with the existing revocation control key;
decrypting the received encrypted K_{g} hash chain value with the new revocation control key; and
obtaining the current device revocation private key by multiplying the K_{g} hash chain value obtained with the device's current device revocation private key; obtaining the inverse of the current device revocation public key by multiplying with the K_{g} hash chain value to obtain the current device revocation private key by the devices to be updated.

12. A method according to claim 11, characterized in that if the device does not have a revocation control key, it requests the revocation control key from other devices; and if the other devices determine that the message from the device requesting the revocation control key is appropriate, they send the device revocation control key using ECIES (Elliptic Curve Integrated Encryption Scheme).

13. A method according to claim 11, characterized in that the devices to be updated, upon detecting that there is at least a difference of two between the latest version information recorded in them and the version information received with the update request, repeating the steps:
creating an intermediate revocation control key by multiplying the received intermediate revocation key;
decrypting the received encrypted K_{g} hash chain value with the intermediate revocation control key;
generating the current intermediate revocation private key by multiplying the K_{g} hash chain value obtained with the device's current device revocation private key; obtaining the inverse of the current device revocation public key by multiplying with the K_{g} hash chain value to obtain the intermediate device revocation private key; and
for the number of differences minus one, i.e., until the K_{g} hash values are obtained and the version just before the most recent one is reached.

14. A method for updating a trusted authority device certificate in a system comprising at least one trusted authority and at least two devices, communicating via a public key infrastructure and performing a method as in claim 5, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.

15. A method for updating a trusted authority device certificate in a system comprising at least one trusted authority and at least two devices, communicating via a public key infrastructure and performing a method as in claim 6, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.

16. A method for updating a trusted authority device certificate in a system comprising at least one trusted authority and at least two devices, communicating via a public key infrastructure and performing a method as in claim 7, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.

17. A method for updating a trusted authority device certificate in a system comprising at least one trusted authority and at least two devices, communicating via a public key infrastructure and performing a method as in claim 8, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.

18. A method for updating a trusted authority device certificate in a system comprising at least one trusted authority and at least two devices, communicating via a public key infrastructure and performing a method as in claim 9, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.

19. A method for updating a trusted authority device certificate in a system comprising at least one trusted authority and at least two devices, communicating via a public key infrastructure and performing a method as in claim 10, characterized by comprising the steps:
deciding on the need for an update;
increasing the version of the trusted authority device certificate by one and sending it to authorized devices for updates, previously calculated;
determining the next PKI hash chain value in a PKI hash chain, with the last value of the chain associated with the first version of the trusted authority device certificate, loaded on each device, and containing successive PKI hash chain values obtained by applying the hash process to the mentioned PKI hash chain values sequentially from the first value;
selecting a random number and multiplying it with a trusted authority public key to create a certificate update intermediate key (K_med);
creating a certificate hash value encryption key (K_cert) by multiplying the certificate update intermediate key (K_med) with a certificate private update key registered at the trusted authority and previously distributed to all devices;
encrypting the determined PKI hash chain value with the mentioned certificate hash value encryption key (K_cert);
sending at least the encrypted PKI hash chain value and the intermediate key in a signed message to the device;
performed by the trusted authority, and repeating these steps for all authorized devices, and comprising the steps:
performing signed verification;
creating a certificate hash value encryption key (K_cert) by multiplying the received certificate update intermediate key with the certificate private update key registered on the device;
obtaining the encrypted PKI hash chain value in the message with the created certificate hash value encryption key;
generating the current certificate private key by multiplying the obtained PKI hash chain value with the certificate private key previously registered on the device, obtaining the current certificate public key by multiplying the current certificate private key with ECC parameters;
generating the current certificate private update key by multiplying the inverse of the current certificate private key with ECC parameters; and
storing the trusted authority device certificate in the received message for use in communication by the device whose certificate will be updated.
